(19) United States
(12) Patent Application Publication
(10) Pub. No.: US 2005/0006991 A1
(43) Pub. Date: Jan. 13, 2005

(54) Snap together modular elements

(76) Inventor: Darren Saravis, Long Beach, CA (US)

Correspondence Address: GREENBERG TRAURIG LLP, 2450 COLORADO AVENUE, SUITE 400E, SANTA MONICA, CA, 90404, US

(21) Appl. No.: 10/462,975

(22) Filed: Jun. 17, 2003

Related U.S. Application Data
(63) Continuation-in-part of application No. 10/425,542, filed on Apr. 28, 2003.
Application No. 10/425,542 is a continuation of application No. 09/759,898, filed on Jan. 13, 2001, now Pat. No. 6,557,955.

(51) Int. Cl. F16B 12/00

(52) U.S. Cl. 312/111

(57) ABSTRACT

A system of constructing modular structures by connecting panels or other parts to one another via snap together latches and/or catches. A connection system using snap together latches and catches, in some cases the latches may have a leading edge to facilitate insertion into a catch.

### BACKGROUND OF THE INVENTION

1. Related Applications

This application is a Continuation-in-Part of U.S. application Ser. No. 10/425,542, filed Apr. 28, 2003 (docket no. 50048400-0007) entitled Snap Together Modular Storage, which is a continuation of U.S. patent application Ser. No. 09/759,898 filed Jan. 13, 2001 entitled Assemble-in-Place Modular Storage, now U.S. Pat. No. 6,557,955, and is hereby incorporated by this reference.

2. Field of the Invention

This present invention relates to a novel snap together storage system. More specifically, to a snap-together method and system of panels, with interlocking edges, from which a variety of self-supporting, storage units, racks, display centers and cabinets may be constructed.

3. Description of the Related Art

Modular storage systems are useful to allow a user to customize a component system to fit his or her particular needs. Panel type storage whereby a similar side panels are connected via edge members are found in U.S. Pat. No. 5,638,973 issued to Dewey et al, and U.S. Pat. No. 5,466,058 issued to Chan. In both Dewey and Chan the containers may be stacked by placing a tab-like projection on the bottom edge of one part into a grove-like indentation in the top of another.

U.S. Pat. No. 5,888,114 issued to Slocum et al., teaches a toy assembly or modular storage system which has a self-supporting edge element to it. The Slocum storage system is a series of similar panels, which form cubes via a slide together extruded mating edge with a catch running down the periphery of one edge and a latch running down the other side. Once two panels are latched in the slide-together fashion, the panel edges can only be disassembled by sliding them apart. Slocum illustrates a plethora of configurations for the slide-in catch and corresponding slide-in latch, all relying on an extruded latch and catch which teaches no alignment guides or stops to maintain the plumb alignment of connected panels. Slocum's slide together mating system connects 4 panels to form a four wall box.

A remaining challenge in the field of modular storage system is to provide similar panels which can snap together at the edges. An additional challenge is to form snap together 5 or 6 sided structures. A further challenge is to facilitate assembly of snap together panels. The present invention overcomes such challenges and prior limitations by creating a snap-in latch and catch panel attachment.

### INVENTION SUMMARY

The present invention is a modular storage system constructed of panels. Each panel has a front and a back side and four edges and four corners. On at least one edge, viewed from a front or a back side is found a latch/catch pair. The sequence of latch to catch is alternating around each side. The catch is elongated having adequate elasticity, memory and/or lubricity to deform and snap-back into place upon insertion or removal of the corresponding elongated latch. In some embodiments the latches are shaped with at least one flattened face to form a leading edge which can facilitate assembly.

Accordingly, a pair of oppositely oriented panels snap together at an edge forming a right angle between the two panels. Additional panels may be added to form structures such as racks, carts, desks, bases, cubes, displays and panels. Each catch may also provide a stop to prevent the latch from sliding within the elongated catch and becoming misaligned. On the edges on each panel a buttress can be formed. Two adjacent buttresses support each other and act as a larger panel support which further stabilizes the structures constructed from the panels.

A support base may be added to distribute the weight of a structure roughly evenly along the bottom surface of a form.

Latches and catches may be formed as part of each panel, on one or both sides. Latches and catches may be attached by slide-on, snap-on, glue mount or through mount at the appropriate locations on a panel. Advantages to attaching the latches and catches rather than molding as one part with a panel include combining dissimilar materials which are impossible or difficult to co-mold, such as a metal sheet, wood or metal grid panel affixed to the latches and catches. Hinged doors, latching hinged doors and wheels may also be added to a cube, panel or structure. Hinges may be supported on the panel covers and a closure catch to receive a closure latch may be combined with latches and/or catches. A magnet and metal plate latch and catch may also be affixed to the panel covers to provide a door closure. The panels may have protruding or recessed surface features which may form a support skeleton for a grid like panel and may be used to provide pathways or guides for shelves and/or drawers. A snap together attachment system is provided that allows latches to be connected to a variety of elements including panels. The system also allows catches to be connected to a variety of elements. Accordingly, the elements (which may take any form which can be connected to the latch or catch) can be attached via the snapped together latch and catch.

Non-cube structures with rectangular side panels may also be formed. Opposing interchangeable side panels can be used to form box-like structures with a multitude of varying dimensional opposing wall pairs.

The features of the invention believed to be novel are set forth with particularity in the appended claim. The invention itself, however, both as to configuration and method of operation, and the advantages thereof, may be best understood by reference to the following descriptions taken in conjunction with the accompanying drawings.

### BRIEF DESCRIPTION OF THE DRAWINGS

FIG. 1A is a front perspective view of the preferred embodiment of the modular storage system.

FIG. 1B is a front view of an unattached corner of one panel of the preferred embodiment.

FIG. 1C is a rear view of an unattached corner of one panel of the preferred embodiment.

FIG. 1D is a perspective view of an attached front corner of the preferred embodiment.

FIG. 1E is a cut-away side view along line A-A of FIG. 1D.

FIG. 2A is a front perspective view of a first alternate embodiment of the modular storage system.

FIG. 2B is a front view of an unattached corner of one panel of the embodiment of FIG. 2A.

FIG. 2C is a rear view of an unattached corner of one panel of the embodiment of FIG. 2A.

FIG. 2D is a blow-up of a front corner connection of the embodiment of FIG. 2A. FIG. 2E is a cut-away side view along line A-A of FIG. 2C.

FIG. 2F is a cut-away edge view of the intersection of four cubes.

FIG. 3A is a front perspective view of a second alternate embodiment of the modular storage system.

FIG. 3B is a blown-up back perspective view of a, slide-on, corner latch/catch of the embodiment of FIG. 3A.

FIG. 3C is a blown-up front perspective view of a, slide-on, corner latch/catch of the embodiment of FIG. 3A.

FIG. 3D is a blow-up rear perspective view of a, slide-on, corner latch/catch of the embodiment of FIG. 3A.

FIG. 3E is a blow-up of a front corner connection of the embodiment of FIG. 3A.

FIG. 3F is a cut-away side view along line A-A of FIG. 3E.

FIG. 4 is a perspective view of one arrangement of the connected panels.

FIG. 5A is a perspective view of a second arrangement of the connected panels.

FIG. 5B is a component view showing the door and attachment to FIG. 5A.

FIG. 5C is a component view showing the wheel and attachment to FIG. 5A.

FIG. 6 is a perspective view of a third arrangement of the connected panels.

FIG. 7 is a front view of a first alternate panel embodiment.

FIG. 8 is a front view of a second alternate panel embodiment.

FIG. 9A is a front a is a is a blow-up rear perspective view of a, slide-on, corner latch/catch with teardrop latch.

FIG. 9B is a cut-away partial side view of the intersection of two panels utilizing the teardrop latch of FIG. 9A.

FIG. 10A is a front view of an unattached panel.

FIG. 10B is a partial view of the unattached panel of FIG. 10A.

FIGS. 11-14 are front views of load distributing bases.

FIG. 15a is a perspective view of a panel structure with door and magnetic closure.

FIG. 15b is a plan view of a corner latch/catch of the embodiment of FIG. 15a.

FIG. 16 is a plan view of a corner latch/catch with closure latch receiving catch.

FIG. 17 is a side view of a corner latch/catch with closure latch receiving catch.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION OF THE PREFERRED EMBODIMENTS

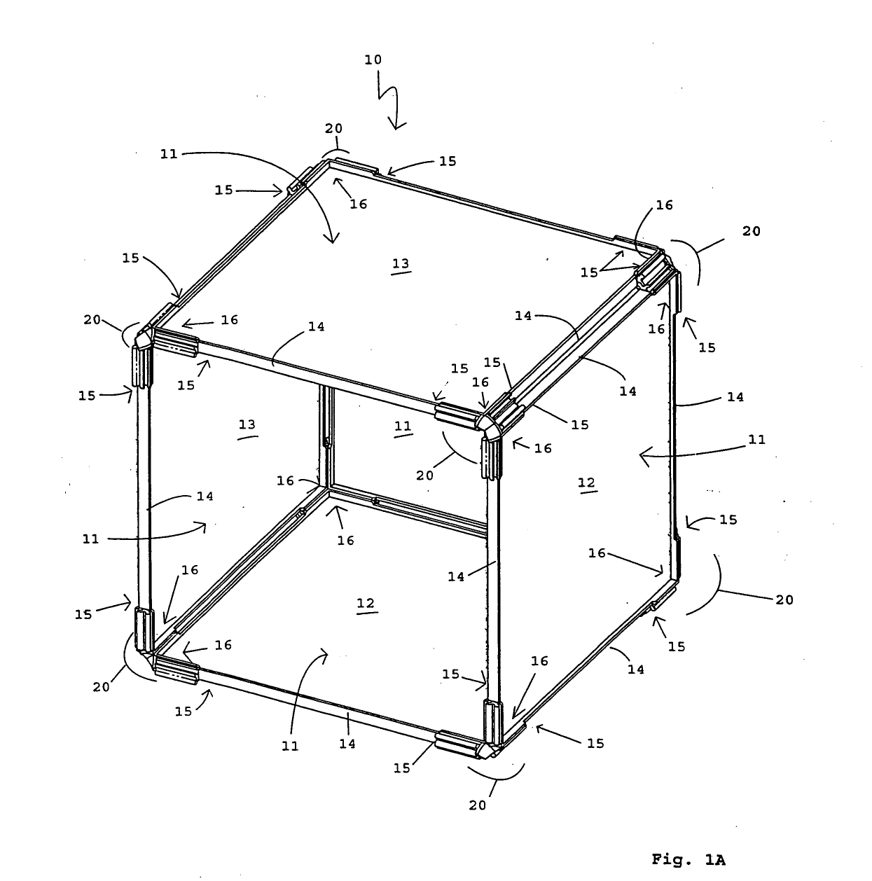

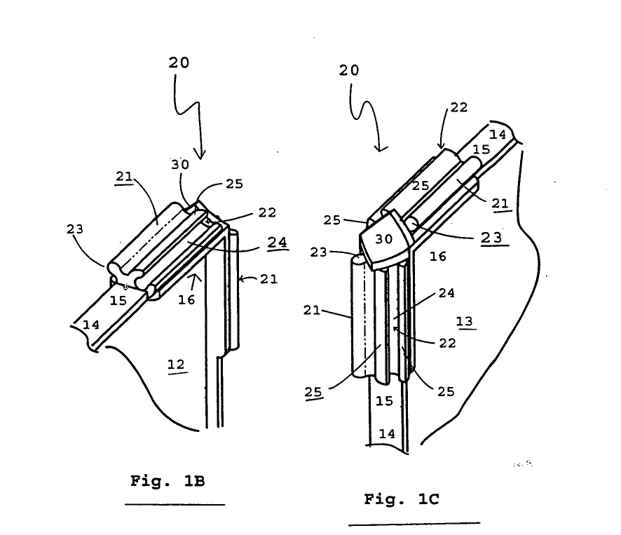

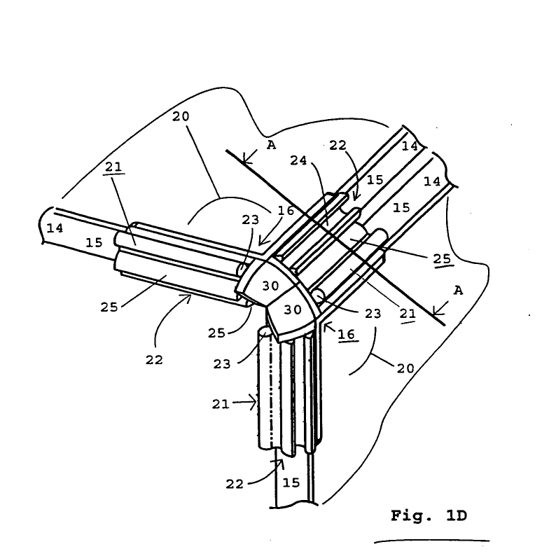

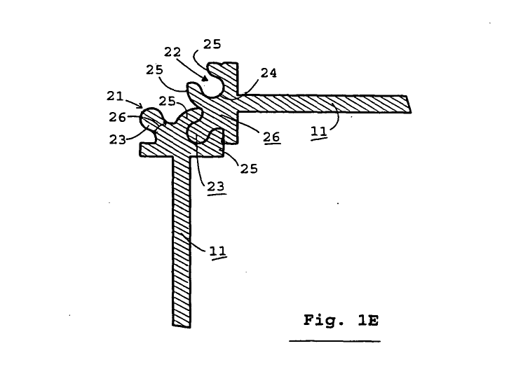

Shown in FIG. 1A is a front perspective view of the preferred embodiment, generally designated 10.

The cube is formed of five four sided panels 11. Each panel has a front 12 and a back side 13 face and an edge 14 at each side. At each end 15, of each edge 14, near the corners 16 of each panel 11, a latch/catch pair 20 is formed. Viewed from the edge 14, a latch 21 and a catch 22 are formed near the corner 16. The latch/catch pairs 20 are reversed such that on any given edge 15 of a panel 11 one latch 21 will be exposed on one side and one catch 22 will be exposed on the other side. This configuration allows alternating panels to be used to construct the entire structure.

Shown in FIG. 1A is a front perspective view of the preferred embodiment, generally designated 10.

The cube is formed of five four sided panels 11. Each panel has a front 12 and a back side 13 face and an edge 14 at each side. At each end 15, of each edge 14, near the corners 16 of each panel 11, a latch/catch pair 20 is formed. Viewed from the edge 14, a latch 21 and a catch 22 are formed near the corner 16. The latch/catch pairs 20 are reversed such that on any given edge 15 of a panel 11 one latch 21 will be exposed on one side and one catch 22 will be exposed on the other side. This configuration allows alternating panels to be used to construct the entire structure.

Shown in FIGS. 1B, 1C, 1D and 1E, are front and rear perspective view of a corner of an unattached panel, a perspective view of an attached front corner and a cut away view of FIG. 1D at line A-A.

In FIGS. 1B & 1C the latches 21 shape is shown, the tab projection forming the latch is elongated with an enlarged head 23 at its distal end which reversibly snaps into the corresponding elongated catch 22 slot 24 and extends at approximately a 45 degree angle from the panel. The panels are preferably an injection molded part constructed out of acrylonitrile-butadiene-styrene “ABS”, Acetal, Acylic or Nylon. However, depending on the intended use, materials such as polycarbonate, polypropylene, polyethylene, or polyurethane may be substituted. An alignment stop 30 is formed at the junction of each edge 14. The alignment stop 30 prohibits the type of movement common to latch/catch panels which are connected via an extruded latch or catch which mount together via a slide-in function. Additionally, as shown in FIG. 1D the alignment stops 30 form a buttress between panels enhancing the structural integrity of the structure.

In FIG. 1E the enlarged head 23 forming the latch is shown mated firmly within the slot 24 of the catch 22, by constructing the catch 22 out of a material with sufficient lubricity, flexibility and/or memory, the enlarged head 23 may be withdrawn or snapped-out of the slot 24 by displacing the slot walls 25 which can snap-back, undamaged, upon withdrawal. A sufficiently flexible slot wall 25 also places less stress on the neck 26 of the latch 21 thereby minimizing the risk of neck damage during attachment or detachment of panels.

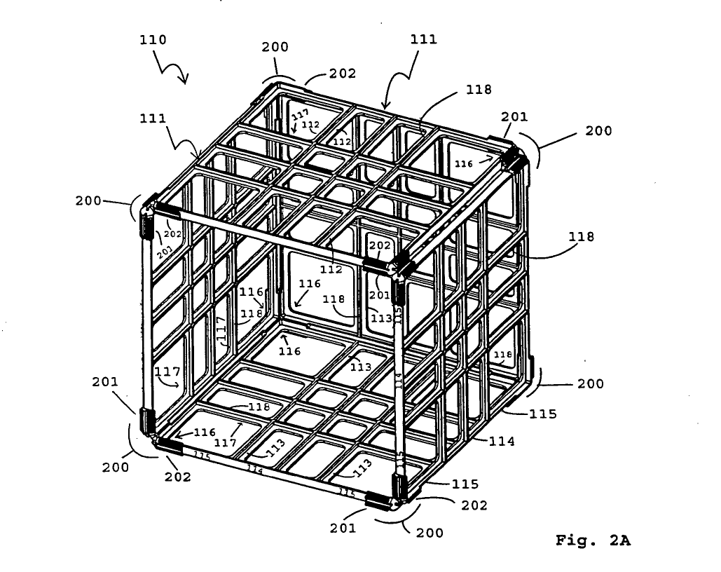

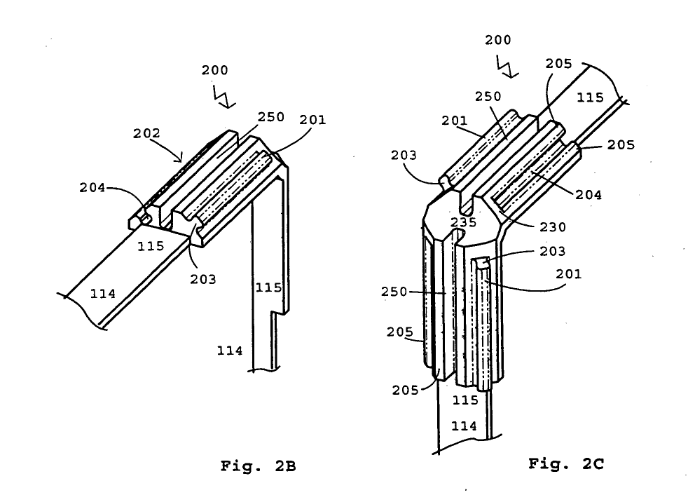

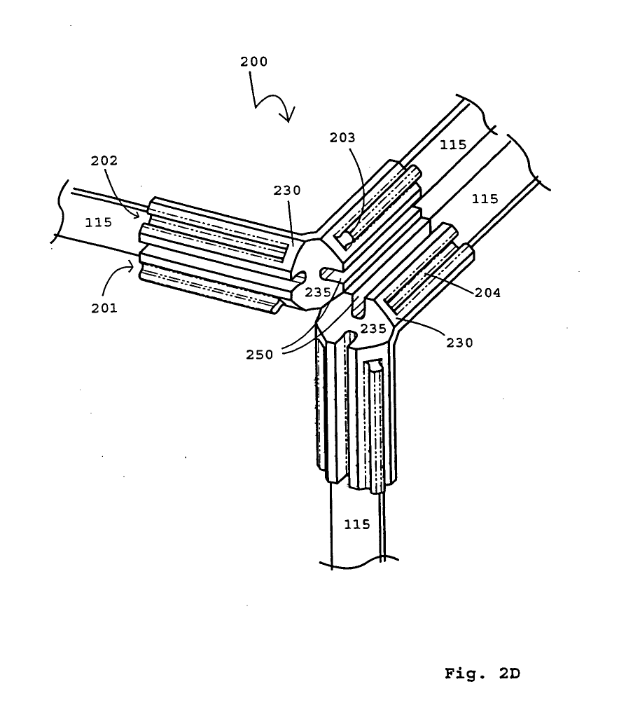

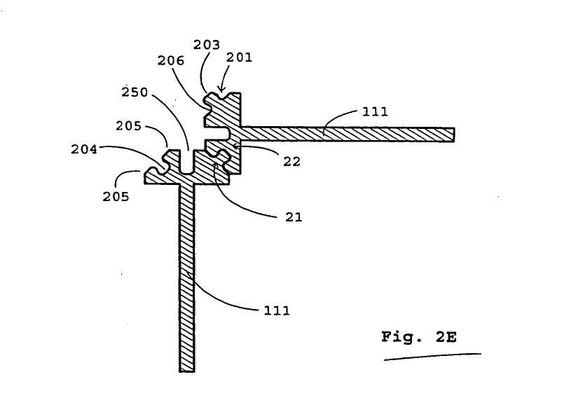

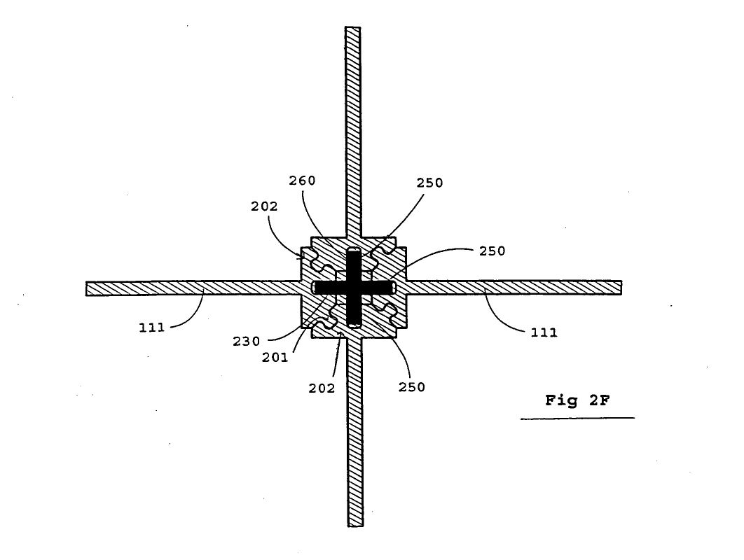

Referring now to FIG. 2A there is illustrated a front perspective view of a first alternate embodiment of the modular storage system, generally designated 110.

The cube is formed of five square panels 111. Each panel 111 is a square frame with an open grid structure formed therein. Each panel has a front 112 and a back side 113 face and an edge 114 at each side. At each end 115, of each edge 114, near the corners 116 of each panel 111, a latch/catch pair 200 is formed. A panel grid 117 is formed within the boundary of the edges 114 and a raised grid support 118 may be extended from the panel grid to provide greater stability to the panel grid 117 and panel 111. Viewed from the edge 114, a latch 201 and a catch 202 are formed near the corner. The latch/catch pairs 200 are reversed such that on any given edge 114 of a panel 111 one latch 201 will be exposed on one side and one catch 202 will be exposed on the other side. This configuration allows similar alternating panels, with corresponding latch/catch pairs 200 to be used to construct the entire structure.

Variations in the side panels are anticipated and discussed within. Side panels may be constructed in a wide variety of forms, with different surface features, cut-outs, skeletal structures, protrusions and the like without departing form the intended scope of the invention. These skilled in the art will recognize that in some instance it may be preferred not to use alternating latches and catches around a panel, but rather to have specific arrangements of latches and/or catches on a panel for a particular usage. Also, those skilled in the art will recognize that latches and catches need not be back to back on either side of a panel to achieve the snap together connection taught herein.

Shown in FIGS. 2B, 2C, 2D and 2E, are a front and rear perspective view of a corner of an unattached panel, a perspective view of an attached front corner, a cut away view of FIG. 2D at line A-A, and a cut-away edge view of the intersection of four cubes.

In FIGS. 2B & 2C the latch 201 shape is illustrated, the tab projection forming the latch has a enlarged head 203 which snaps in a reversible fashion into the corresponding catch 202 slot 204. The panels are preferably an injection molded part constructed out of polypropylene, ABS, polycarbonate or nylon which provides flexibility and durability. An alignment stop 230 is formed at the junction of each edge 114. The alignment stop 230, adjacent to an angular corner buttress 235, prohibits forward and back movement of a latch 201 within a catch 202. Additionally, the combination of two or more adjacent corner buttresses 235 (FIG. 2D) forms a larger corner support further enhancing the structural integrity of the structure.

In FIG. 2D the enlarged head 203 forming the latch is shown mated firmly within the slot 204 forming the catch 202, by constructing the panels out of a material with sufficient flexibility, memory and/or lubricity the enlarged head 203 may be withdrawn or snapped-out of the slot 204 without damaging the slot walls 205 or the neck 206 of the latch 201. A support guide 250 is formed between the latch 201 and the catch 202. In FIG. 2F a support rod 260 of a size and shape to mate with the support guide 250 is shown. The support rod can be used to preclude removal of a panel when such action needs to be restricted, as may be the case with young children or in commercial, school or business locations.

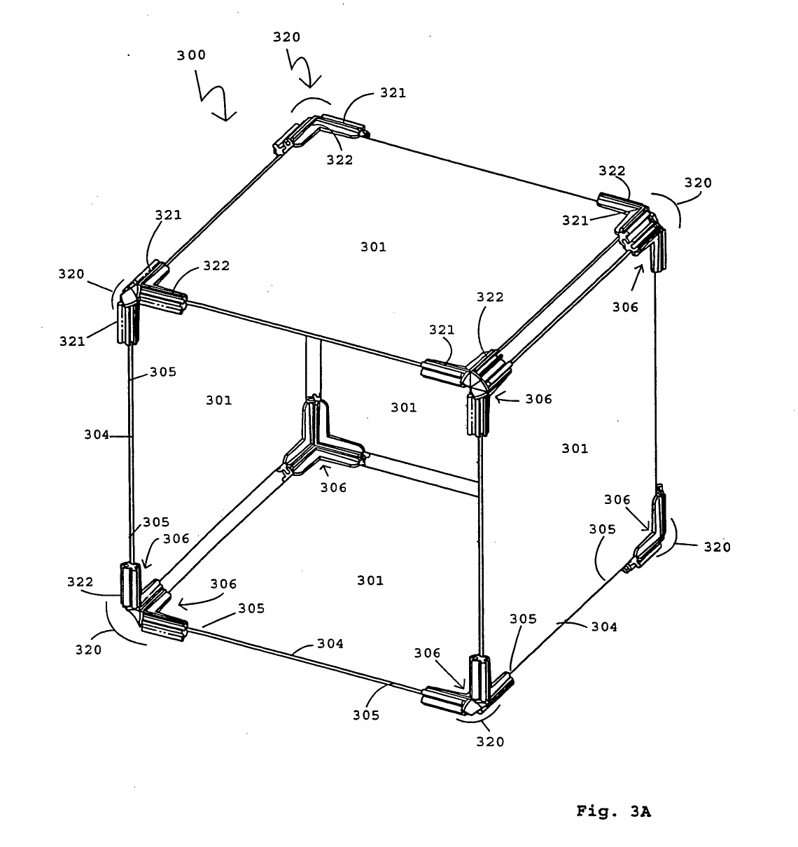

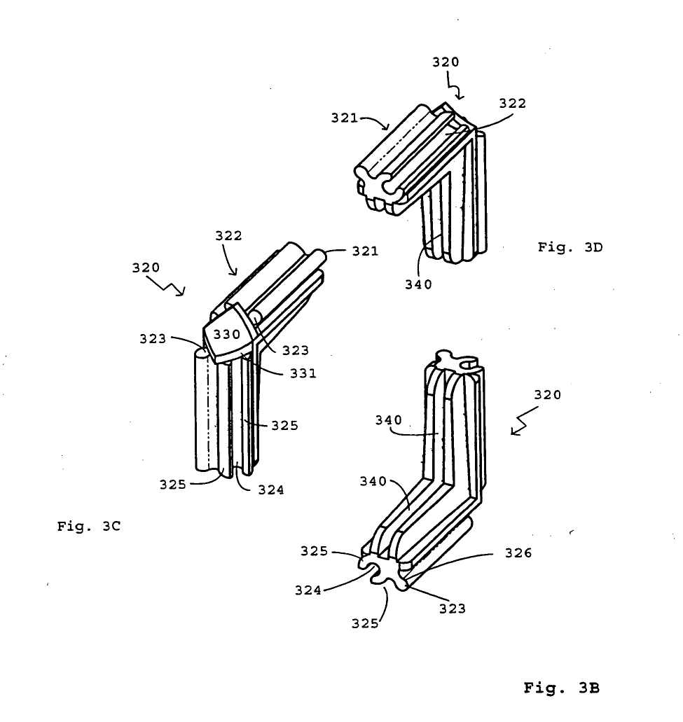

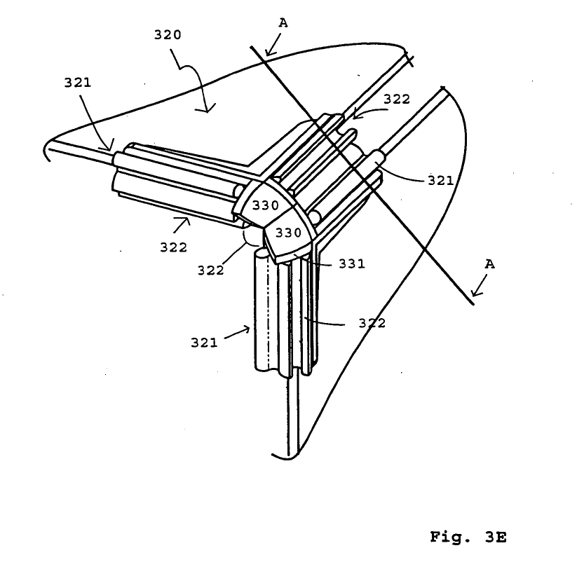

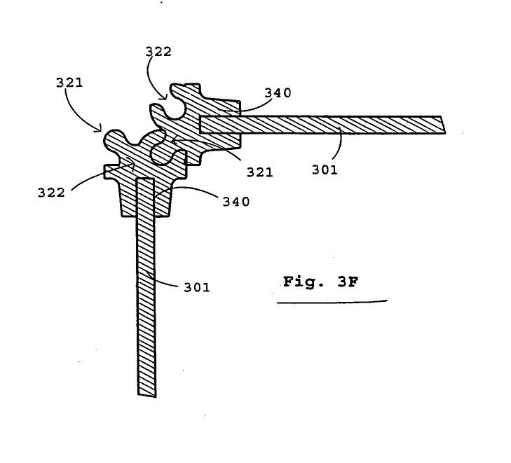

FIG. 3A shows a front perspective view of a second alternate embodiment of the modular storage system, generally designated 300.

The cube is formed of five panels 301. Each panel 301 is of a similar size. Each panel side has an edge 304. At each end 305, of each 304, near the corners 306 of each panel 301, a latch/catch pair 320 is affixed. Viewed from the edge 304, latch 321 and a catch 322 are attached near the corner 306. The latch/catch pairs 320 are reversed such that on any given edge 304 of a panel 301 one latch 321 will be exposed on one side and one catch 322 will be exposed on the other side. This configuration allows alternating panels to be used to construct the entire structure.

In FIGS. 3B, 3C, 3D, 3E and 3F, there is shown a front, back and rear perspective view of the slide-on corner catch/latch, a perspective view of an attached front corner, a cut away view of FIG. 3E at line A-A, and a cut-away edge view of the intersection of four cubes.

In FIGS. 3B, 3C, and 3D the latch 321 shape is illustrated, the tab projection forming the latch is elongated and has a enlarged head 323 which snaps in a reversible fashion into the corresponding catch 322 slot 324. The latch/catch pairs 320 are preferably an injection molded part constructed out of polypropylene, ABS, polycarbonate, high durometer rubber, or nylon which provides flexibility and durability. An alignment stop 330 is formed at the corner junction of each latch/catch pairs 320. FIG. 3E illustrates the position of the alignment stops 330 which inhibits movement of a latch 321 within a catch 322 thereby enhancing the structural integrity of the structure. Surrounding each corner buttress 330 is a support edge 331 which engages an adjacent support edge 331 of a panel affixed adjacent and forms the larger corner support 332. A panel mating guide 340 is formed opposite each latch/catch pair 320. It is via this panel mating guide 340 that each panel 301 is fitted into the latch/catch pair 320. It is envisioned that each panel 301 will be solidly affixed to the panel mating guide 340. The nature of the attachment will be dependent on the material the panel is constructed of, adhesives, locking tabs, sonic welds, glue, rivets, crimping, slide-over, slide-in, and the like may be used.

Variations in the side panels are anticipated and discussed within. A non-exclusive list of possible side panel materials are framed wire mesh, coated wire, plastic grids, wood, metal, plastic, composites, sheet steel (stainless, hot or cold rolled carbon steel, or any alloy), brass, or copper stamped or formed, woven metal or plastic and metal frames inserted molded into plastic.

In FIG. 3F the enlarged head 323 forming the latch is shown mated firmly within the slot 324 forming the catch 322. By constructing the latch/catch pairs 320 out of a material with sufficient lubricity the enlarged head 323 may be withdrawn or snapped-out of the slot 324 without damaging the slot walls 325 or the neck 326 of the latch 321.

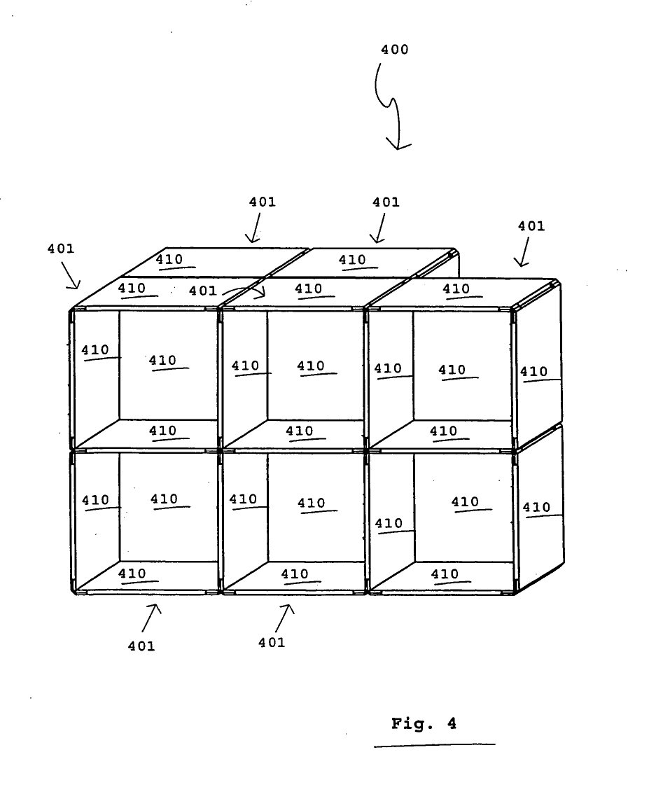

Shown in FIG. 4 there is illustrated a perspective view of one arrangement of the connected panels, generally designated 400.

A series of cubes 401 are attached together with one panel 410 acting as a common panel shared between cubes 401. A latch-catch pair (as described in FIGS. 1-3) is found on opposite sides of each panel 410 to facilitate snap together construction of the cubes 401.

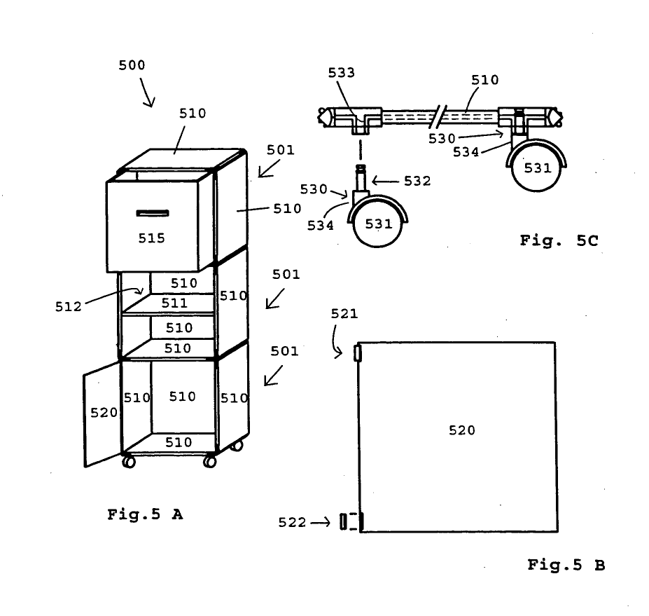

Shown in FIGS. 5A, 5B and 5C there is a perspective view of a second arrangement of the connected panels, generally designated 500 forming a vertical storage case with wheels (FIG. 5C) and a swing door (FIG. 5B).

A series of cubes 501 are attached together (as described in FIGS. 1-4) constructed out of identical panels 510 forming a tower. A shelf member 511 is held within a guide 512 formed as part of the surface feature of the panels 510.

A hinged door 520 attaches to one of the cubes 501 via a hinge which has on latch 521 and one catch 522 (as described in FIGS. 1-3). A group of removable caster-type wheel modules 530 are affixed one per bottom corner, to the tower 500. Each wheel module 530 has one wheel 531 and rod 532, which mates with a boss 533 formed in each corner of the bottom panel 510. Each rod 532 extends from a wheel stop 534 and mates with the boss 533.

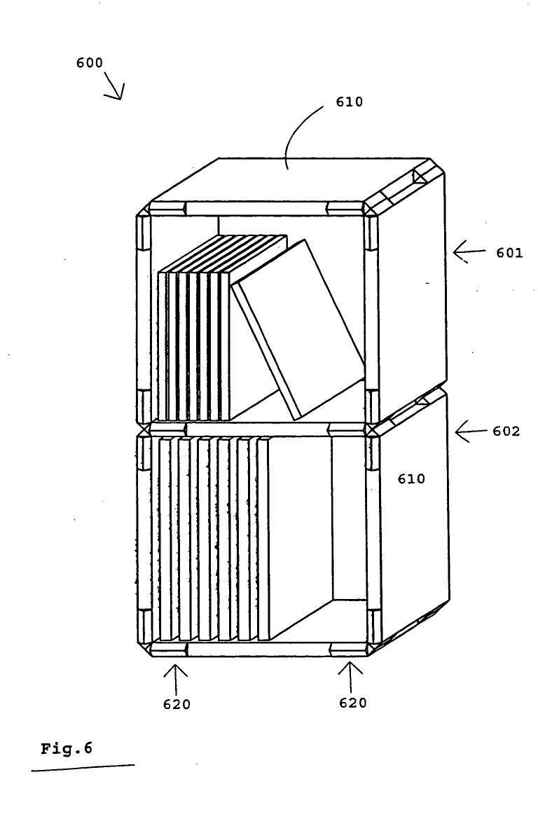

Shown in FIG. 6 there is a perspective view of a third arrangement of the connected panels, generally designated 600.

A series of cubes 601 are attached together (as described in FIGS. 1-4) constructed out of panels 610 forming a tower. In the configuration the cubes 601 are of a scale for desktop use to hold pads, paper, pens, clips, computer disks, CDs or other media storage devices. A series of rubber pads 620 may be affixed to the bottom surface of the lower cube 601 to inhibit slippage on a desktop.

Shown in FIGS. 7 & 8 there are front views of a first and second alternate panel embodiments generally designated 700 & 800 respectively.

In FIG. 7 there is a metal and plastic panel which has a wire insert 701 embedded within a preferably clear or translucent plastic structure 702, within a four sided square frame 703. On opposite ends of each side of the square frame 703 a latch 704 and a catch 705 (as previously described in FIGS. 1-3) are affixed, or formed as a part thereof. On the back face (not shown) of the panel 700 opposite each latch 704 is a catch 705 and opposite each catch 705 is a latch 704.

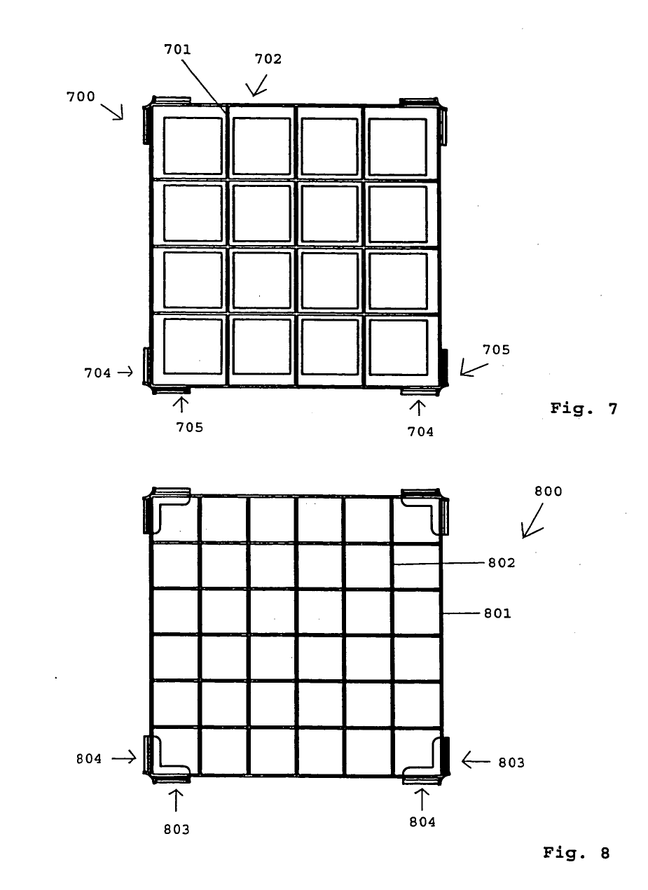

In FIG. 8 a square four sided frame 801 supports a central mesh 802 affixed at opposite ends of each side of the square frame 801 is a latch 803 and a catch 804 (as previously described in FIGS. 1-3). On the back face (not shown) of the panel 800 opposite each latch 803 is a catch 804 and opposite each catch 804 is a latch 803. The square frame 801 and/or the mesh 802 may be constructed of plastic, metal or metal coated with a rubber-like material, lacquered, painted or metal plated.

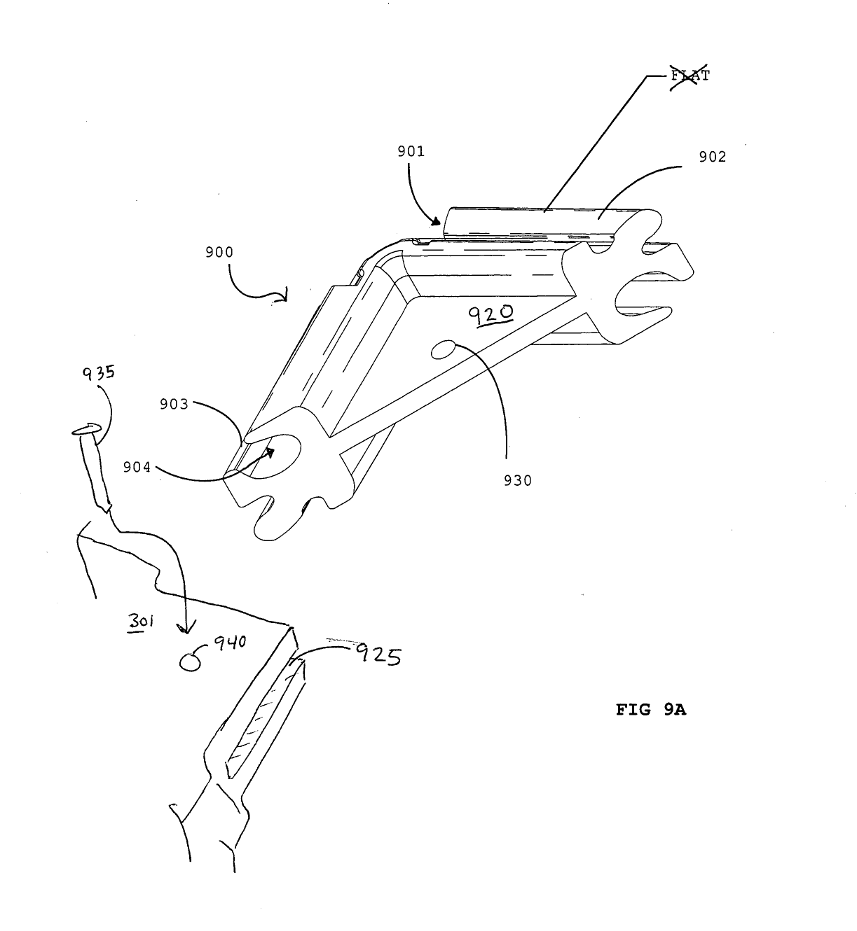

In FIGS. 9A and 9B a corner panel cover 900 is shown. A latch/catch pair is supported on each edge of the corner panel cover 900. The latch 901 is a tab projection with an enlarged head 902 which snaps in a reversible fashion into the corresponding catch 903 slot 904. The corner panel cover 900 is preferably an injection molded part constructed out of a material which is flexible and durable to provide for the snap-in and snap-out attachment such as polypropylene, ABS, polycarbonate, high durometer rubber, or nylon. An alignment stop 905 is formed on the corner panel cover 900.

To affix each corner panel cover 900 to a panel, a panel mating guide 920 on the corner panel cover 900, fits into a connector slot 925 at the corner of the panel 301. The corner panel cover 900 can be held in the connector slot with an adhesive, glue or an attachment fastener, a non-exclusive list of fasteners which may be suitable include nails, rivets, screws, nuts and bolts, pins, swaged connectors, and barbed connectors. To fastener mount a corner panel cover 900, a fastener guide 930 formed in the panel mating guide 920 receives a fastener 935 which is also connected to the panel 301 via a fastener channel 940 on either side of the connector slot 925.

The enlarged head 902 is supported on a neck 942. The enlarged head has one flattened face 944. The flattened face 944 forms a leading edge 945 for insertion into the corresponding slot 904. During insertion of the latch 901 into the catch 903, the enlarged head 902 displaces and reversibly deforms the slot walls 946. Upon complete insertion of the enlarged head 902 the slot walls 946 become less deformed thereby securing the enlarged head 902 in place.

The illustration of a smooth flattened face 944 in the figures is not a limitation. The flattened face may be configured in a concave fashion or a complex surface. The functionality of the flattened face 944 is to provide a leading edge 945 for insertion into the slot 903.

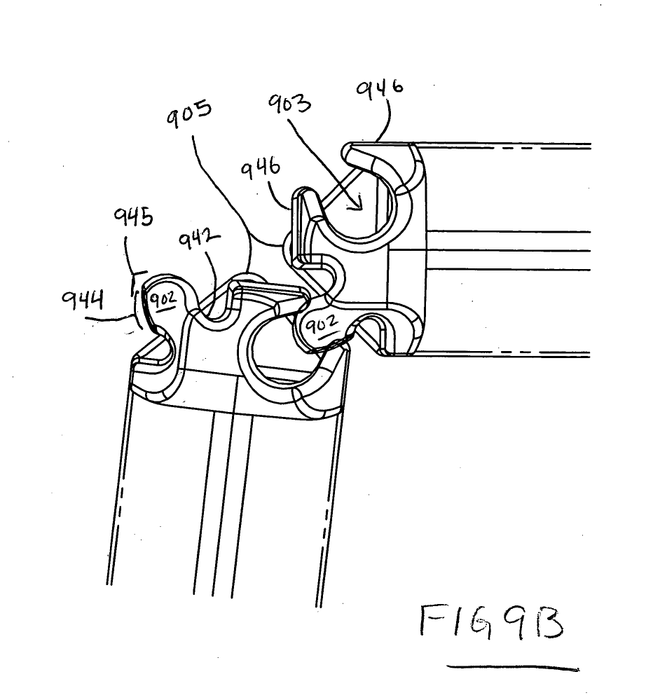

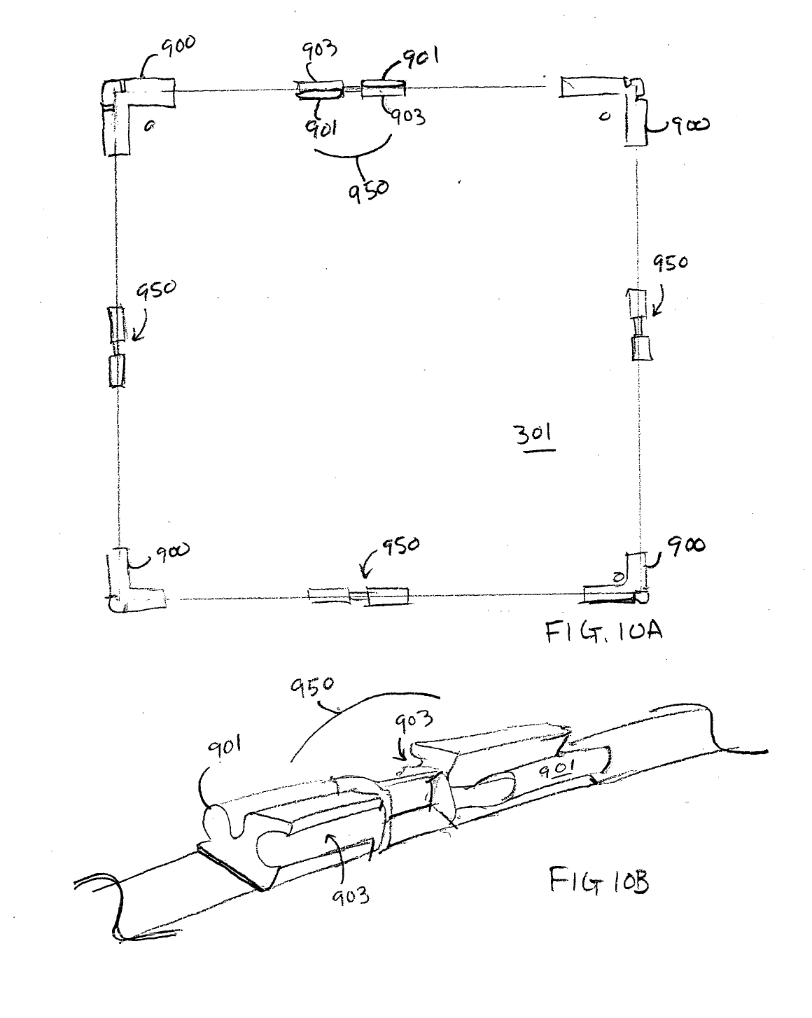

In FIGS. 10A and 10B a panel 301 with both corner panel covers 900 and linear attachment body 950 is shown. The linear attachment body 950 provides two latches 901 and two catches 903. The latches and catches on the attachment body 950 may be connected to the panel 301 (or other elements) by molding the attachment body 950 as part of the panel, co-molding, adhesives, locking tabs, sonic welds, glue, rivets, crimping, slide-over, or slide-in mounting of the linear latch/catch pair as generally described in reference to FIGS. 1-3. Each opposing linear attachment body 950 as shown with an alternating latch 901 and catch 903. In this embodiment, it is preferable that the latches 901 and catches 903 alternate as they are located around the panel. However, those skilled in the art will recognize that in some instances it may be advantageous to have a different order to the latches and catches around a panel.

FIGS. 11-14 show several support bases. The support base 1000 (a substantially horizontal load bearing plate) shown in FIG. 11 is constructed of a rigid material, the preferred material being wood, steel, aluminium. Other suitable materials include acrylonitrile-butadiene-styrene “ABS”, nylon, plastic, polycarbonate, polypropeleyne, polyethylene. Feet 1002 are mounted to the bottom 1003 of the support base 1000. A lowered area 1004 corresponding to each latch/catch pair 320 on the bottom panel 301b is formed on the top surface 1005 of the support base 1000. A raised area 1006 corresponding to the bottom panel 301b is also formed on the top surface 1005. The bottom panel 301b is part of a greater structure formed of other panels 301 such as those shown in FIG. 4. The support base 1000 therefore holds a bottom panel 301b with latch/catch pairs 320 connected. The lowered areas 1004 and the raised areas 1006 provided on the top surface 1005 of the support base 1000 roughly distribute the load (weight of the supported structure formed of connected panels and any objects or items therein) evenly on the bottom panel 301b. At least a portion of both the bottom panel 301b and each latch/catch pair 320 should make contact with the top surface 1005. Absent the support base 1000 the latch/catch pairs 320 on the bottom panel 301b, resting on a hard surface, would have a greater load concentrated at each latch/catch pairs 320 than on the panel 301b.

The illustration of separate feet is not a limitation. Those skilled in the art will recognize that a single platform or other spacer element, which is load bearing, may be placed under the support base 1000 without departing from the scope of the invention.

In FIG. 12 a base support 1020 with a flat bottom 1022 and variable top surface 1023 is shown. Lowered portions support latches and/or catches and a raised portion 1025 supports a bottom panel 301b. A single base support 1020 can support one or more bottom panels 301b and any structures formed therefrom.

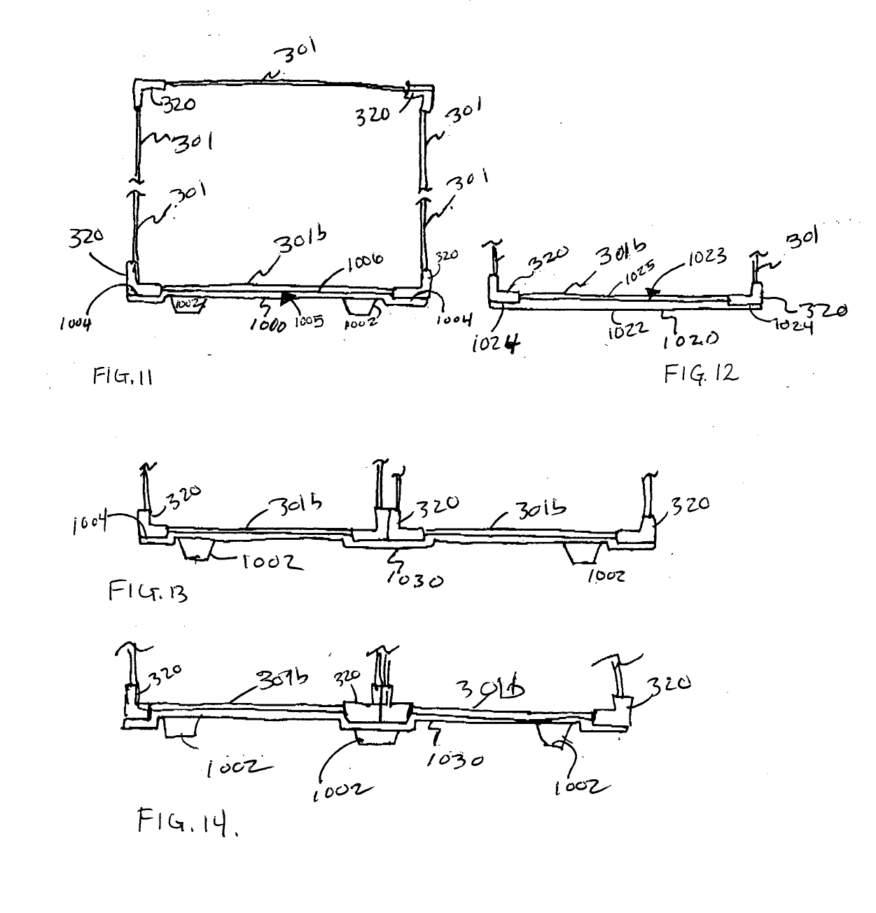

The support base 1030 shown in FIGS. 13 and 14 supports multiple bottom panels 301b. Depending on the expected load and material the support base 1030 is constructed from, in some embodiments, the support base 1030 may have a lesser or greater number of feet 1002.

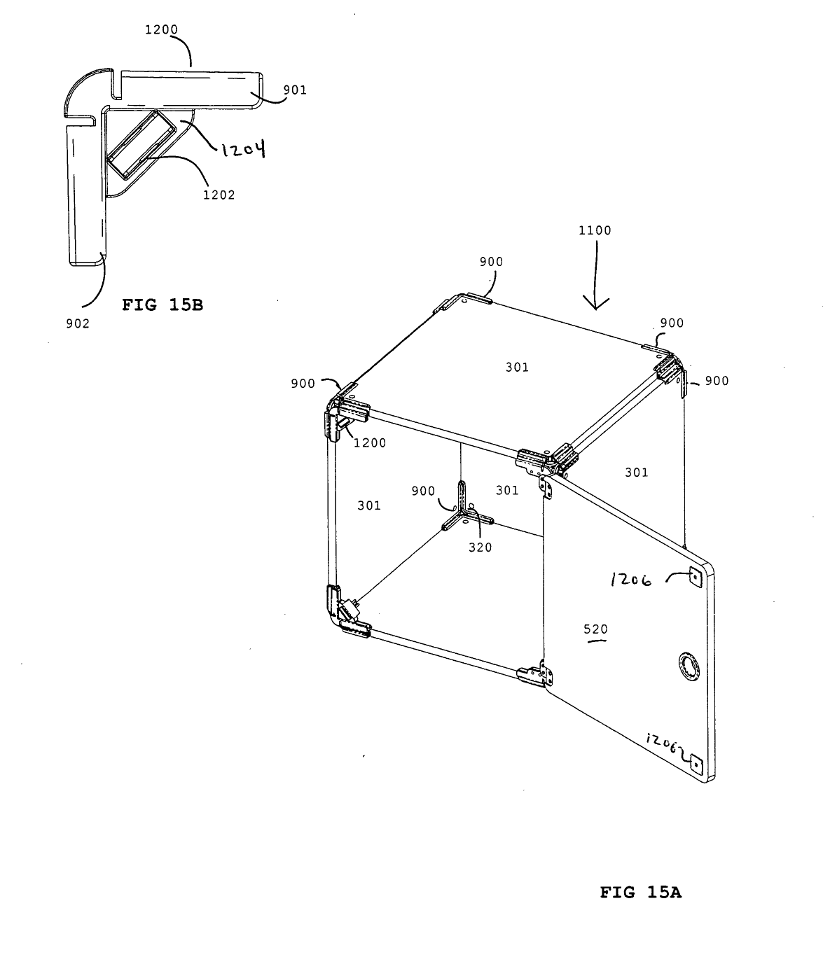

A storage structure formed from a group of connected panels 301 with connector slot (not shown) and corner panel covers 900 is shown in FIG. 15A. The door 520 and the structure 1100 is hinged as described in reference to FIG. 5A. Shown in FIG. 15B is a corner panel cover 1200 with a magnet 1202 affixed to a magnet guide 1204. In this embodiment the magnet guide 1204 functions to support the magnet 1202 for door closure. The corner panel cover 1200 with magnet guide 1204 is affixed to the structure via the latch 901 and catch 903 of adjacent corner panel covers 900. A metallic plate 1206 is attached to the inside of the door 520 in a location corresponding to the location of the magnets 1202. Although two metallic plates 1206 and two magnets 1202 are shown those skilled in the art will recognize that a greater or lesser number of magnets or metallic plates may be substituted.

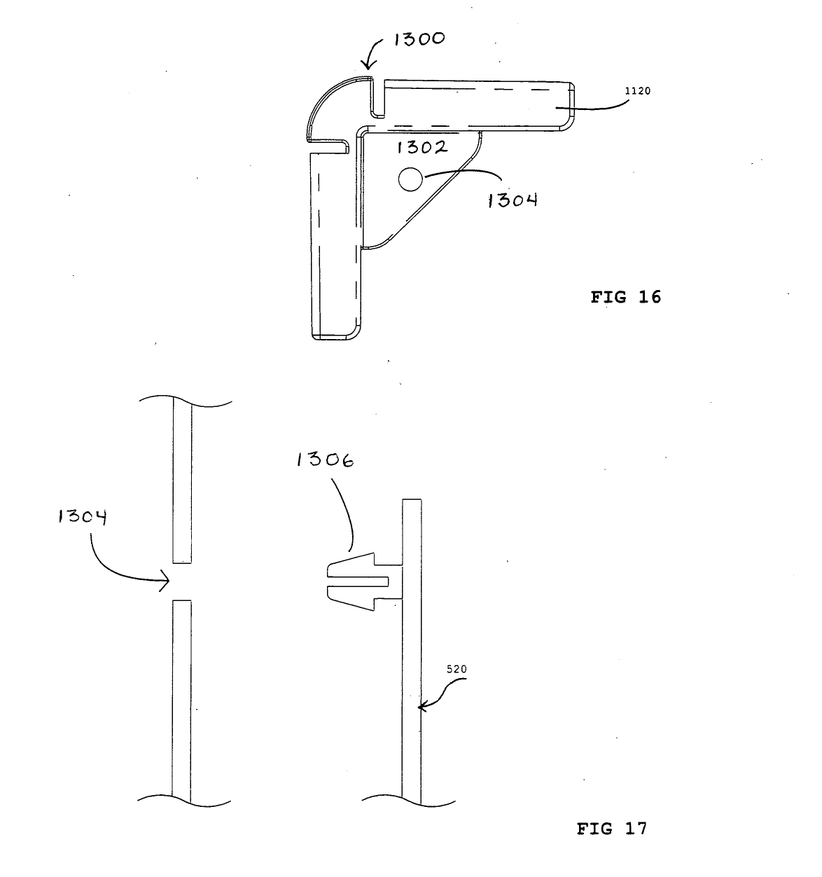

Another corner panel cover 1300 with a closure guide 1302 and closure catch 1304 is shown in FIGS. 16 and 17. A barbed latch 1306 attached to the door panel 520 reversibly mates with the closure catch formed in the closure guide 1302 to hold the door 520 against a structure (not shown). Those skilled in the art will recognize that the barb latch 1306 may be formed or affixed to the mating guide 920 and the closure catch 1302 may be formed in the door 520 without departing from the scope of the invention.

Since certain changes may be made in the above apparatus without departing from the scope of the invention herein involved, it is intended that all matter contained in the above description, as shown in the accompanying drawing, shall be interpreted in an illustrative, and not a limiting sense.

1. A snap together connection comprising:
an elongated latch with an enlarged head;
an elongated catch with flexible slot walls; and
a flattened surface on the enlarged head forming a leading edge; whereby the elongated latch is snapped into the elongated catch via the leading edge.

2. The connection of claim 1 wherein at least one of the elongated latch and the elongated catch is formed on an attachment body.

3. The connection of claim 1 wherein at least one of the elongated latch and the elongated catch is formed on a corner cover.

4. The connection of claim 1 wherein the elongated latch and the elongated catch are formed on a corner cover.

5. The connection of claim 4 wherein the elongated latch and the elongated catch are formed on the front side of the corner cover.

6. The connection of claim 5 further comprising at least one of an elongated latch and elongated catch is formed on the backside of the corner cover.

7. A snap together connector system comprising;
a first attachment body;
a latch with an enlarged head formed on the first attachment body;
a second attachment body; and
an elongated catch with flexible slot walls formed on the second attachment body.

8. The connector system of claim 7 further comprising a flattened surface on the enlarged head forming a leading edge; whereby the elongated latch reversibly is snapped into the elongated catch via the leading edge.

9. The connector system of claim 7 further comprising an elongated catch with flexible slot walls formed opposite the elongated latch on the first attachment body.

10. A snap together connector system comprising;
a first corner cover;
a latch with an enlarged head and flattened surface formed on the first corner cover;
a catch with flexible slot walls formed on the first corner cover;
a second corner cover;
a latch with an enlarged head formed on the second corner cover; and
a catch with flexible slot walls formed on the second corner cover.

11. The connector system of claim 10 further comprising a flattened surface formed as part of the enlarged heads of the latch on the second corner cover.

12. A support base comprising:
a substantially horizontal load bearing plate with a bottom and a top surface; and
at least one of a raised area and a lowered area formed on the top surface, whereby the latch or catch on a bottom panel of a modular structure make at least partial contact with the top surface.

13. The support base of claim 12 further comprising at least one spacer element beneath the bottom of the substantially horizontal load bearing plate.

14. The support base of claim 12 further comprising a plurality of feet affixed to the bottom of the substantially horizontal load bearing plate.
